(19) United States
(12) Patent Application Publication
(10) Pub. No.: US 2016/0238428 A1
(43) Pub. Date: Aug. 18, 2016

(54) DEVICE AND METHOD FOR MEASURING LIQUID LEVEL

(71) Applicant: ELECTRONICS AND TELECOMMUNICATIONS RESEARCH INSTITUTE, Daejeon (KR)

(72) Inventor: Jang Sup CHOI, Daejeon (KR)

(73) Assignee: ELECTRONICS AND TELECOMMUNICATIONS RESEARCH INSTITUTE, Daejeon (KR)

(21) Appl. No.: 15/046,063

(22) Filed: Feb. 17, 2016

(30) Foreign Application Priority Data
Feb. 17, 2015 (KR) 10-2015-0023933

(51) Int. Cl. G01F 23/292

(52) U.S. Cl. CPC G01F 23/292

(57) ABSTRACT

The present disclosure relates to a liquid level measurement method and a liquid level measurement device using a fiber optic sensor. The device according to the present disclosure includes a fiber optic sensing unit configured to detect displacement of a metal rod fixed in a liquid storage tank according to inflow and outflow of a liquid into and from the liquid storage tank and a liquid level meter configured to measure a liquid level in the liquid storage tank using the displacement.

### CROSS-REFERENCE TO RELATED APPLICATION(S)

This application claims the priority benefit of Korean Patent Application No. 10-2015-0023933 filed on Feb. 17, 2015, in the Korean Intellectual Property Office, the disclosure of which is incorporated herein by reference.

### BACKGROUND

1. Technical Field

Embodiments relate to a liquid level measurement device and a liquid level measurement method using a fiber optic sensor.

2. Description of the Related Art

There are a variety of conventional liquid level measuring techniques. For example, conventional liquid level measuring techniques may include a capacitance method using a capacitance change according to a liquid level change, a method using a change in thermal inertia of a residual propellant by electric heating used in a satellite tank, a pressure method using a pressure change, a gravity method using a weight change, a method of gauging a modification in buoyancy device by a liquid level change using optical fiber, a method of measuring a resonance frequency according to the size of an empty space of a structure by emitting ultrasonic waves, or the like.

However, the conventional measurement techniques may be used for limited applications depending on methods and have precision issues to supplement. Further, systems for achieving the conventional measurement techniques have complicated structures due to complexity of processing.

In particular, a conventional water level measuring technique using a fiber optic sensor has a plurality of disadvantages. For example, the conventional water level measuring technique using the fiber optic sensor only allows intermittent water level measurement, rather than continuous measurement of a water level change. Further, the conventional water level measuring technique using the fiber optic sensor conducts only limited measurement and water level detection within a short distance. Thus, it is needed to overcome the foregoing disadvantages for accuracy and practical application.

Thus, it is required to develop a device and a method capable of overcoming disadvantages of water level measurement using a fiber optic sensor, conducting measurement regardless of liquid type, and achieving precise measurement with a simple configuration.

### SUMMARY

An aspect is to detect a natural frequency of a metal rod responding to vibrations using a fiber optic sensor and to measure a liquid level according to the natural frequency, thereby safely and precisely achieving liquid level measurement with a simple configuration.

Another aspect is to adjust a tension of the metal rod which may vary according to temperature in the liquid storage tank, thereby measuring an accurate liquid level using the metal rod with a constant tension regardless of temperature difference.

According to an aspect, there is provided a device for measuring a liquid level including a fiber optic sensing unit configured to detect displacement of a metal rod fixed in a liquid storage tank according to inflow and outflow of a liquid into and from the liquid storage tank, and a liquid level meter configured to measure a liquid level in the liquid storage tank using the displacement.

According to an aspect, there is provided a method of measuring a liquid level including detecting, by a fiber optic sensor, displacement of a metal rod fixed in a liquid storage tank according to inflow and outflow of a liquid into and from the liquid storage tank, and measuring a liquid level in the liquid storage tank using the displacement.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 is a block diagram illustrating a liquid level measurement device according to an embodiment;

FIG. 2 illustrates a liquid storage tank in which a liquid level measurement device is installed according to an embodiment;

FIG. 3 illustrates a configuration of a liquid level measurement device when a metal rod is a metal wire according to an embodiment;

FIG. 4 illustrates a configuration of a liquid level measurement device with one end of a metal rod connected according to an embodiment;

FIG. 5 illustrates a liquid level measurement process by a liquid level meter according to an embodiment; and

FIG. 6 is a flowchart specifically illustrating a liquid level measurement method according to an embodiment.

### DETAILED DESCRIPTION

Reference will now be made in detail to embodiments of the present disclosure, examples of which are illustrated in the accompanying drawings, wherein like reference numerals refer to the like elements throughout. Embodiments are described below to explain the present disclosure by referring to the figures.

A liquid level measurement device and a liquid level measurement method described in this specification may measure a liquid level based on a liquid level measurement set at each natural frequency using a natural frequency of a metal rod responding to vibrations. Hereinafter, although the present disclosure will be described with reference to a metal rod, which is for convenience of description, the metal rod may be replaced with a metal wire, a spiral metal wire of a plurality of metal wires bound, or the like according to embodiments. Further, “liquid level” repeatedly used in this specification collectively refers to not only “water height” but also “liquid height.”

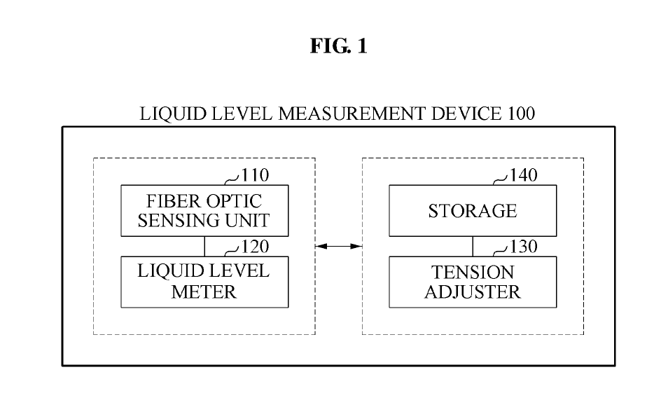

FIG. 1 is a block diagram illustrating a liquid level measurement device according to an embodiment.

The liquid level measurement device 100 may include a fiber optic sensing unit 110 and a liquid level meter 120. Further, depending on an embodiment, the liquid level measurement device 100 may further include a tension adjuster 130 and a storage 140.

First, the fiber optic sensing unit 110 detects displacement of a metal rod fixed in a liquid storage tank according to inflow and outflow of a liquid into and from the liquid storage tank. The fiber optic sensing unit 110 may detect displacement of the metal rod reacting to vibrations using a fiber optic sensor. Here, displacement may refer to a change in natural vibration of the metal rod or a period of the natural vibration of the metal rod. That is, the fiber optic sensing unit 110 may detect a period of displacement by vibrations in the metal rod using the fiber optic sensor. Further, vibrations may include a phenomenon occurring to the liquid storage tank by inflow and outflow of a liquid or an impact.

The metal rod may be fixed inside the liquid storage tank. Here, the metal rod may be fixed with one end or both ends being connected to an interior side of the liquid storage tank. That is, both ends of the metal rod may be connected vertically to the interior side of the liquid storage tank or one end thereof may be connected vertically to the interior side of the liquid storage tank.

The metal rod may be at least one of a thin metal rod or metal wire (for example, piano wire) sensitively responding to vibrations.

The liquid storage tank may be at least one of a liquid storage tank of a satellite, a liquid storage tank of a projectile, a mobile storage tank (for example, airplane, ship, and car), a petrochemical storage tank, and a nuclear energy related storage tank.

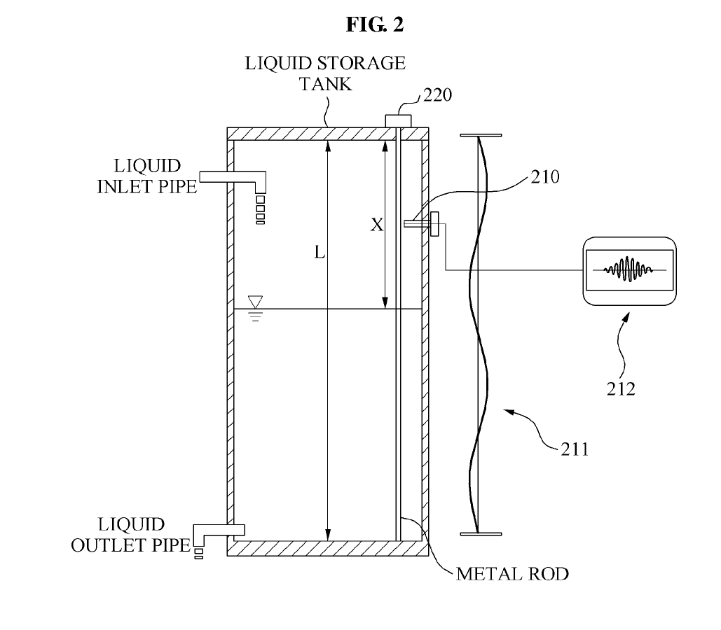

A configuration of the liquid level measurement device installed in the liquid storage tank will be described in detail with reference to FIGS. 2 to 4.

The liquid level meter 120 measures a liquid level in the liquid storage tank using the displacement. That is, the liquid level meter 120 may measure a liquid level using a change in natural frequency of the metal rod detected by the fiber optic sensing unit 110. A process of measuring a liquid level will be described in detail with reference to FIGS. 2 to 5.

The tension adjuster 130 may adjust tension applied to the metal rod when both ends of the metal rod are connected and fixed to the interior side of the liquid storage tank. That is, when both ends of the metal rod are fixed, the tension adjuster 130 may adjust tension applied to the metal rod in order to offset a tension change affecting precision.

The tension adjuster 130 may be mounted inside or outside the liquid storage tank according to a thickness of the metal rod to adjust the tension. For example, the tension adjuster 130 may be mounted inside the liquid storage tank to adjust tension when the metal rod is a metal wire. The tension adjuster 130 and the metal rod will be described in detail with reference to FIGS. 2 to 4.

FIG. 2 illustrates a liquid storage tank in which a liquid level measurement device is installed according to an embodiment.

The liquid level measurement device 100 may be installed in the liquid storage tank and measure a level of a liquid stored in the liquid storage tank.

First, a fiber optic sensing unit 210 may be installed in the liquid storage tank such that a fiber optic sensor is adjacent to a metal rod. The fiber optic sensing unit 210 may detect 211 displacement of the metal rod responding to vibrations occurring inside or outside the liquid storage tank. Further, the fiber optic sensing unit 210 may analyze the displacement to detect 212 a change in natural frequency of the metal rod. The fiber optic sensing unit 210 will be described in detail with reference to FIG. 1.

Further, a tension adjuster 220 connected to the metal rod may be installed outside the liquid storage tank. Here, the metal rod may be a thin rod with both ends fixed. The tension adjuster 220 may adjust tension of the metal rod so that the metal rod does not deteriorate precision by tension. In this description, both ends of the metal rod are fixed, without being limited thereto.

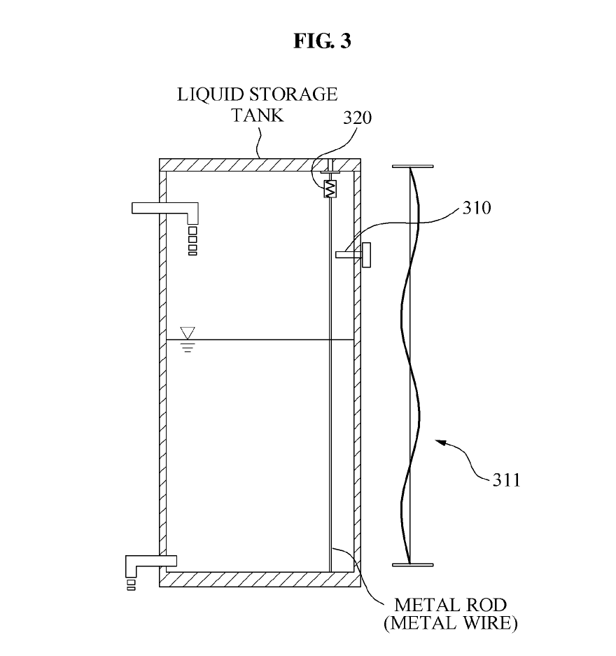

FIG. 3 illustrates a configuration of a liquid level measurement device when a metal rod is a metal wire according to an embodiment.

As illustrated in FIG. 3, a fiber optic sensing unit 310 may be installed on a wall of a liquid storage tank such that a fiber optic sensor is adjacent to the metal rod. Here, when the metal rod is a metal wire, both ends of the metal wire may be fixed to an interior side of the liquid storage tank and a tension adjuster 320 to adjust tension of the metal wire may be mounted inside. The metal wire may have 311 a different natural frequency from the metal rod illustrated in FIG. 2.

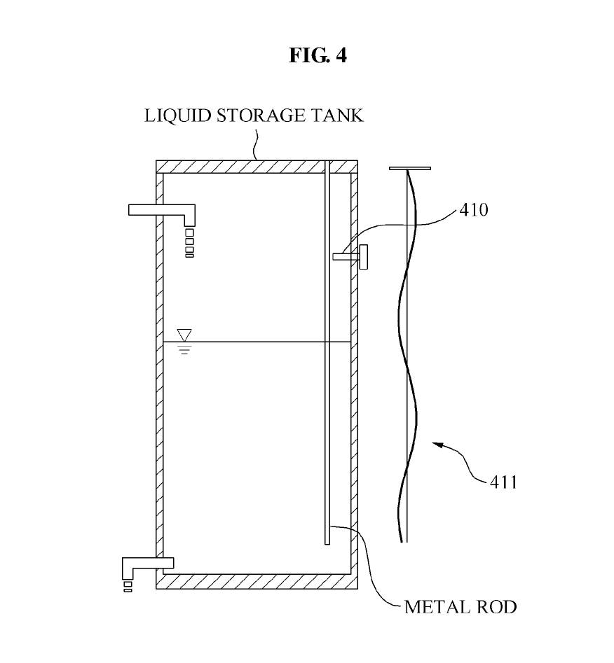

FIG. 4 illustrates a configuration of a liquid level measurement device with one end of a metal rod connected according to an embodiment.

As illustrated in FIG. 4, the metal rod may be fixed in a cantilever manner. A fiber optic sensing unit 410 may be installed to close to the metal rod fixed to an upper portion of a liquid storage tank. The fiber optic sensing unit 410 may detect displacement of the metal rod slightly vibrating by vibrations. The metal rod may have 411 a different natural frequency from the metal rod with both ends fixed illustrated in FIG. 2.

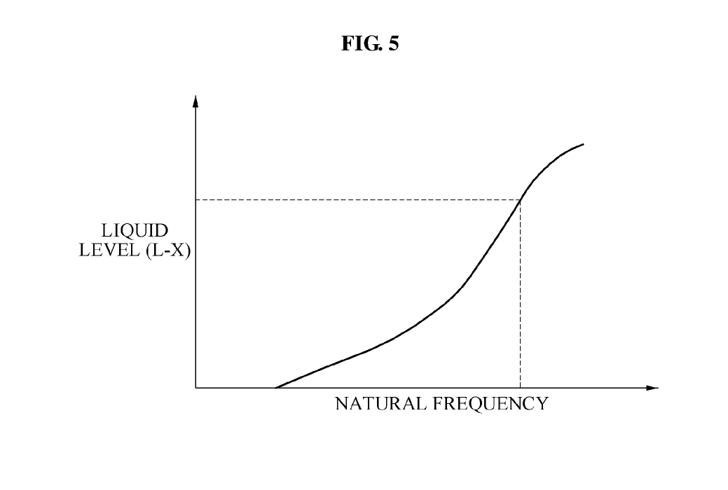

FIG. 5 illustrates a liquid level measurement process by a liquid level meter according to an embodiment.

The liquid level meter 120 may measure a liquid level using a change in natural frequency of a metal rod, because a natural frequency of the metal rode before inflow and outflow of a liquid may be different from a natural frequency of the metal rod after inflow and outflow of the liquid.

A detailed description will be made with reference to FIG. 2.

First, a liquid level may be a difference between a total length L of the metal rod and a length X of a portion of the metal rod which is not submerged in the liquid. For example, when the liquid is introduced through a liquid inlet pipe, the length X of the portion of the metal rod which is not submerged in the liquid may become short as an amount of the liquid introduced increases. Thus, the difference (L-X) between the total length L of the metal rod and the length X of the portion which is not submerged in the liquid may increase in proportion to the amount of the introduced liquid. Alternatively, when the liquid is discharged through a liquid outlet pipe, the length X of the portion which is not submerged in the liquid may become long as an amount of the liquid discharged increases. Thus, the difference (L-X) between the total length L of the metal rod and the length X of the portion which is not submerged in the liquid may decrease in inverse proportion to the amount of the discharged liquid.

To sum up, the difference (L-X) with respect to the metal rod may become great or small according to inflow and outflow of the liquid. Here, the metal rod may have a different natural frequency according to the difference L-X, since the natural frequency of the metal rod may vary on damping effect of the portion submerged in the liquid. Using this principle, a liquid level measurement may be measured at a separate natural frequency. Further, liquid level measurements measured by natural frequencies may be different. Here, the liquid level measurements measured by natural frequencies may be preset and stored in a database.

As illustrated in FIG. 5, a liquid level (L-X) by natural frequency may be expressed in a graph. The liquid level meter 120 may retrieve a liquid level set for detected displacement (that is, natural frequency) from the database, thereby measuring a liquid level at the natural frequency.

For reference, although the present specification describes that the liquid level measurement device 100 measures a liquid level of a liquid, the liquid level measurement device 100 may gauge at least one of a liquid level, volume, and mass according to data stored in the database. For example, when the database stores data obtained by gauging a mass by natural frequency, the liquid level measurement device 100 may retrieve a mass by natural frequency from the database to measure a mass.

Referring back to FIG. 1, when vibrations occur by inflow and outflow of the liquid, the fiber optic sensing unit 110 may detect, as displacement, a change in natural frequency caused by movement of the metal rod responding to the vibrations. That is, when the metal rod is moved by vibrations occurring by inflow and outflow of the liquid, the fiber optic sensing unit 110 may detect a change in natural frequency of the metal rod.

Further, the fiber optic sensing unit 110 may detect, as displacement, a change in natural frequency according to a degree to which at least part of the metal rod is submerged in the liquid. That is, the fiber optic sensing unit 110 may detect a change in natural frequency using a principle that the natural frequency changes according to the degree to which the metal rod is submerged in the liquid.

Further, the fiber optic sensing unit 110 may detect a change in natural frequency from a low-frequency region to a high-frequency region with an increase in the degree to which the metal rod is submerged in the liquid. That is, the fiber optic sensing unit 110 may detect a change in natural frequency from a low-frequency region to a high-frequency region with an increase in damping effect occurring in the portion of the metal rod submerged in the liquid and a decrease in length of the portion of the metal rod which is not submerged in the liquid.

The liquid level meter 120 may calculate a liquid level change using a plurality of natural frequencies as follows.

First, the fiber optic sensing unit 110 may measure a first natural frequency of the metal rod before inflow and outflow of the liquid and a second natural frequency of the metal rod after inflow and outflow of the liquid. For example, the fiber optic sensing unit 110 may measure a first natural frequency of the metal rod before inflow of the liquid and a second natural frequency of the metal rod after inflow of the liquid.

Here, the fiber optic sensing unit 110 may measure numbers of vibrations of the metal rod per given unit time as the first and second natural frequencies. That is, the fiber optic sensing unit 110 may transform a natural vibration mode of the metal rod in a frequency domain, thereby measuring the first and second natural frequencies.

Next, the liquid level meter 120 may gauge a difference between liquid level measurements retrieved from the database, respectively corresponding to the first and second natural frequencies, to calculate a liquid level change in the liquid storage tank. That is, the liquid level meter 120 may retrieve a liquid level measurement corresponding to the first natural frequency from the database and retrieve a liquid level measurement corresponding to the second natural frequency from the database. Then, the liquid level meter 120 may gauge a difference between the liquid level measurements to calculate a change in liquid level.

Here, the storage 140 may store the liquid level measurements set by the respective natural frequencies in the database. That is, the storage 140 may store a natural frequency changing on a different liquid level in the database. The liquid level meter 120 may retrieve a liquid level measurement corresponding to each natural frequency stored in the database.

The liquid level measurement device 100 according to the present disclosure may detect a natural frequency of a metal rod responding to vibrations using a fiber optic sensor and measure a liquid level according to the natural frequency, thereby safely and precisely achieving liquid level measurement with a simple configuration.

Further, the liquid level measurement device 100 according to the present disclosure may adjust a tension of the metal rod which may vary according to temperature in the liquid storage tank, thereby measuring an accurate liquid level using the metal rod with a constant tension regardless of temperature difference.

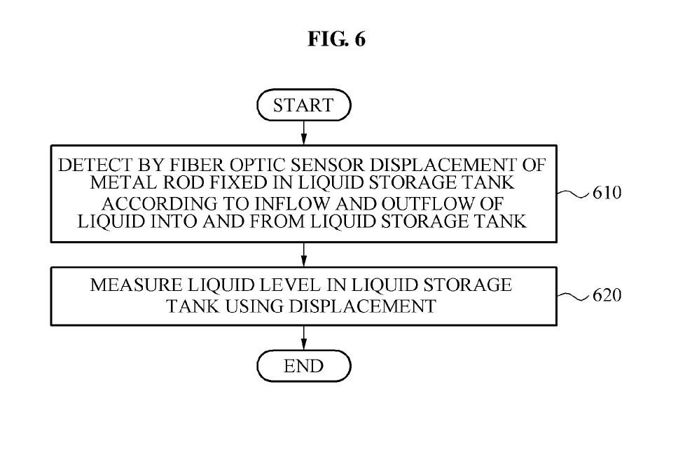

FIG. 6 is a flowchart specifically illustrating a liquid level measurement method according to an embodiment.

The liquid level measurement method according to the present embodiment may be performed by the foregoing liquid level measurement device 100.

First, the liquid level measurement device 100 detects displacement of a metal rod fixed in a liquid storage tank according to inflow and outflow of a liquid into and from the liquid storage tank in operation 610.

That is, operation 610 may be a process of detecting displacement of the metal rod reacting to vibrations. Here, displacement may refer to a change in natural vibration of the metal rod or a period of the natural vibration of the metal rod. That is, the liquid level measurement device 100 may detect a period of displacement by vibrations in the metal rod using a fiber optic sensor. Further, vibrations may include a phenomenon occurring to the liquid storage tank by inflow and outflow of a liquid or an impact.

The metal rod may be fixed inside the liquid storage tank. Here, the metal rod may be fixed with one end or both ends being connected to an interior side of the liquid storage tank. That is, both ends of the metal rod may be connected vertically to the interior side of the liquid storage tank or one end thereof may be connected vertically to the interior side of the liquid storage tank.

The metal rod may be at least one of a thin metal rod or metal wire (for example, piano wire) sensitively responding to vibrations.

The liquid storage tank may be at least one of a liquid storage tank of a satellite, a liquid storage tank of a projectile, a mobile storage tank (for example, airplane, ship, and car), a petrochemical storage tank, and a nuclear energy related storage tank.

Operation 610 may also be a process of detecting, as displacement, a change in natural frequency according to a degree to which at least part of the metal rod is submerged in the liquid. That is, the liquid level measurement device 100 may detect a change in natural frequency using a principle that the natural frequency changes according to the degree to which the metal rod is submerged in the liquid.

Further, operation 610 may be a process of detecting a change in natural frequency from a low-frequency region to a high-frequency region with an increase in the degree to which the metal rod is submerged in the liquid. That is, the liquid level measurement device 100 may detect a change in natural frequency from a low-frequency region to a high-frequency region with an increase in damping effect occurring in the portion of the metal rod submerged in the liquid and a decrease in length of the portion of the metal rod which is not submerged in the liquid.

In addition, operation 610 may be a process of detecting, as displacement, a change in natural frequency caused by movement of the metal rod responding to vibrations when the vibrations occur by inflow and outflow of the liquid. That is, when the metal rod is moved by vibrations occurring by inflow and outflow of the liquid, the liquid level measurement device 100 may detect a change in natural frequency of the metal rod.

Next, the liquid level measurement device 100 measures a liquid level in the liquid storage tank using the displacement in operation 620. That is, operation 620 may be a process of measuring a liquid level using a change in natural frequency of the metal rod detected by the fiber optic sensor.

According to an embodiment, the liquid level measurement device 100 may measure a first natural frequency of the metal rod before inflow and outflow of the liquid and a second natural frequency of the metal rod after inflow and outflow of the liquid and gauge a difference between liquid level measurements retrieved from the database, respectively corresponding to the first and second natural frequencies, thereby calculating a liquid level change in the liquid storage tank.

For example, the liquid level measurement device 100 may measure a first natural frequency of the metal rod before inflow of the liquid and a second natural frequency of the metal rod after inflow of the liquid. Subsequently, the liquid level measurement device 100 may retrieve a liquid level measurement corresponding to the first natural frequency from the database and retrieve a liquid level measurement corresponding to the second natural frequency from the database. Then, the liquid level measurement device 100 may gauge a difference between the liquid level measurements to calculate a change in liquid level.

According to an embodiment, the liquid level measurement device 100 may measure numbers of vibrations of the metal rod per given unit time as the first and second natural frequencies. That is, the liquid level measurement device 100 may transform a natural vibration mode of the metal rod in a frequency domain, thereby measuring the first and second natural frequencies.

According to an embodiment, the liquid level measurement device 100 may store the liquid level measurements set by the respective natural frequencies in the database. That is, the liquid level measurement device 100 may store a natural frequency changing on a different liquid level in the database. Stored data may be used later to retrieve a liquid level measurement corresponding to each natural frequency.

According to an embodiment, the liquid level measurement device 100 may adjust tension applied to the metal rod when both ends of the metal rod are connected and fixed to the interior side of the liquid storage tank. That is, when both ends of the metal rod are fixed, the liquid level measurement device 100 may adjust tension applied to the metal rod in order to offset a tension change affecting precision.

According to an embodiment, the liquid level measurement device 100 may be mounted inside or outside the liquid storage tank according to a thickness of the metal rod to adjust the tension. For example, the tension adjuster 130 may be mounted inside the liquid storage tank to adjust tension when the metal rod is a metal wire.

The liquid level measurement method according to the present disclosure may detect a natural frequency of a metal rod responding to vibrations using a fiber optic sensor and measure a liquid level according to the natural frequency, thereby safely and precisely achieving liquid level measurement with a simple configuration.

Further, the liquid level measurement method according to the present disclosure may adjust a tension of the metal rod which may vary according to temperature in the liquid storage tank, thereby measuring an accurate liquid level using the metal rod with a constant tension regardless of temperature difference.

According to an embodiment, a natural frequency of a metal rod responding to vibrations may be detected using a fiber optic sensor and a liquid level may be measured according to the natural frequency, thereby safely and precisely achieving liquid level measurement with a simple configuration.

Further, a tension of the metal rod which may vary according to temperature in the liquid storage tank may be adjusted, thereby measuring an accurate liquid level using the metal rod with a constant tension regardless of temperature difference.

The methods according to the embodiments may be realized as program instructions implemented by various computers and be recorded in non-transitory computer-readable media. The media may also include, alone or in combination with the program instructions, data files, data structures, and the like. The program instructions recorded in the media may be designed and configured specially for the embodiments or be known and available to those skilled in computer software. Examples of the non-transitory computer readable recording medium may include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine codes, such as produced by a compiler, and higher level language codes that may be executed by the computer using an interpreter. The described hardware devices may be configured to act as one or more software modules in order to perform the operations of the above-described exemplary embodiments, or vice versa.

While a few example embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A device for measuring a liquid level, the device comprising:
a fiber optic sensing unit configured to detect displacement of a metal rod fixed in a liquid storage tank according to inflow and outflow of a liquid into and from the liquid storage tank; and
a liquid level meter configured to measure a liquid level in the liquid storage tank using the displacement.

2. The device of claim 1, wherein the fiber optic sensing unit detects, as the displacement, a change in natural frequency according to a degree to which at least part of the metal rod is submerged in the liquid.

3. The device of claim 2, wherein the fiber optic sensing unit detects the change in natural frequency from a low-frequency region to a high-frequency region with an increase in the degree to which the metal rod is submerged in the liquid.

4. The device of claim 1, wherein when vibrations occur by inflow and outflow of the liquid, the fiber optic sensing unit detects, as the displacement, a change in natural frequency caused by movement of the metal rod responding to the vibrations.

5. The device of claim 1, wherein the fiber optic sensing unit measures a first natural frequency of the metal rod before inflow and outflow of the liquid and a second natural frequency of the metal rod after inflow and outflow of the liquid, and
the liquid level meter gauges a difference between liquid level measurements retrieved from a database respectively corresponding to the first and second natural frequencies to calculate a liquid level change in the liquid storage tank.

6. The device of claim 5, wherein the fiber optic sensing unit measures numbers of vibrations of the metal rod per given unit time as the first and second natural frequencies.

7. The device of claim 5, further comprising a storage configured to store the liquid level measurements set for respective natural frequencies in the database.

8. The device of claim 1, wherein the metal rod is fixed with both ends or one end being connected to an interior side of the liquid storage tank.

9. The device of claim 1, further comprising a tension adjuster configured to adjust tension applied to the metal rod when both ends of the metal rod are connected and fixed to the interior side of the liquid storage tank.

10. The device of claim 9, wherein the tension adjuster is mounted inside or outside the liquid storage tank according to a thickness of the metal rod to adjust the tension.

11. A method of measuring a liquid level, the method comprising:
detecting displacement of a metal rod fixed in a liquid storage tank according to inflow and outflow of a liquid into and from the liquid storage tank; and
measuring a liquid level in the liquid storage tank using the displacement.

12. The method of claim 11, wherein the detecting of the displacement comprises detecting, as the displacement, a change in natural frequency according to a degree to which at least part of the metal rod is submerged in the liquid.

13. The method of claim 12, wherein the detecting of the displacement further comprises detecting the change in natural frequency from a low-frequency region to a high-frequency region with an increase in the degree to which the metal rod is submerged in the liquid.

14. The method of claim 11, wherein when vibrations occur by inflow and outflow of the liquid, the detecting of the displacement comprises detecting, as the displacement, a change in natural frequency caused by movement of the metal rod responding to the vibrations.

15. The method of claim 11, further comprising:
measuring a first natural frequency of the metal rod before inflow and outflow of the liquid and a second natural frequency of the metal rod after inflow and outflow of the liquid, and
gauging a difference between liquid level measurements retrieved from a database respectively corresponding to the first and second natural frequencies to calculate a liquid level change in the liquid storage tank.

16. The method of claim 15, further comprising measuring numbers of vibrations of the metal rod per given unit time as the first and second natural frequencies.

17. The method of claim 15, further comprising storing the liquid level measurements set for respective natural frequencies in the database.

18. The method of claim 11, wherein the metal rod is fixed with both ends or one end being connected to an interior side of the liquid storage tank.

19. The method of claim 11, further comprising adjusting tension applied to the metal rod when both ends of the metal rod are connected and fixed to the interior side of the liquid storage tank.

20. The method of claim 19, wherein the adjusting of the tension comprises adjusting the tension inside or outside the liquid storage tank according to a thickness of the metal rod.
